(19) United States
(12) Patent Application Publication
(10) Pub. No.: US 2026/0111927 A1
(43) Pub. Date: Apr. 23, 2026

(54) HEALTH OUTCOMES THROUGH AN INCENTIVE-BASED PATIENT ENGAGEMENT AND EDUCATION SYSTEM

(71) Applicant: Hygia Technologies LLC, Miami, FL (US)

(72) Inventors: Alexander Shaknovich, New York, NY (US); Stanislav Gutkin, Mt. Arlington, NJ (US)

(21) Appl. No.: 18/924,106

(22) Filed: Oct. 23, 2024

(51) Int. Cl. G06Q 30/0226; G09B 5/06

(52) U.S. Cl. CPC G06Q 30/0226; G09B 5/065

(57) ABSTRACT

The present disclosure relates to patient healthcare, patient education, and patients, engaging patients, and habituating patients to behaviors for the purpose of improving health outcomes through the use of an adaptive, incentive-based application.

### CROSS-REFERENCE TO RELATED APPLICATION

NONE.

### FIELD

The present disclosure relates to patient healthcare, patient education, and in particular to systems, devices, applications, and methods for educating patients, engaging patients, and habituating patients to behaviors for the purpose of improving health outcomes through the use of an adaptive, incentive-based application.

### BACKGROUND

Patient education and health engagement are critical elements in promoting positive health outcomes. Informed patients are better equipped to understand their health conditions, treatment options, and the steps necessary to manage or prevent disease. This education empowers individuals to make well-informed decisions about their care, ultimately leading to better adherence to prescribed treatments, healthier lifestyle choices, and improved self-management of chronic conditions.

When patients are knowledgeable about their health, they can take an active role in preventing complications and minimizing hospital readmissions, which contributes to a higher quality of life and reduces healthcare costs.

Health engagement extends beyond education; it encompasses the active participation of patients in their own care. Engaged patients are more likely to ask questions, voice concerns, and collaborate with healthcare providers in developing care plans that are tailored to their unique needs and preferences. This partnership fosters trust and communication between patients and providers, which is essential for effective healthcare delivery. Patients who are engaged are also more likely to follow through with treatment plans, attend follow-up appointments, and adhere to medication regimens, all of which play a crucial role in preventing adverse health events and promoting long-term wellness.

In addition, patient education and engagement are particularly important for managing chronic diseases, which often require ongoing monitoring and lifestyle adjustments. For example, patients with conditions such as diabetes, heart disease, or asthma benefit from understanding how to manage their symptoms, to recognize warning signs, and to make dietary or activity-related changes. Educated and engaged patients can better prevent exacerbations, avoid emergency care, lower instances of hospitalization, and maintain a stable condition. Furthermore, in an age where health information is widely accessible, patient education can help individuals discern credible sources of information from misinformation, leading to more informed choices about their health.

Ultimately, patient education and engagement contribute to a more patient-centered approach to healthcare. This approach not only improves health outcomes but also increases patient satisfaction and strengthens the overall healthcare experience. By fostering a sense of empowerment, both education and engagement enable patients to take ownership of their health, leading to healthier communities and a more effective healthcare system.

Patient-provider long-term relationship building essential for developing patient competence and skills is a demanding and time-consuming task currently not adequately emphasized in provider training, supervision, or reimbursement. AI-assisted long-term patient engagement is likely to emerge as a useful strategy for enhancing and complementing such relationship-building.

Deficiencies in patient engagement with associated lack of required patient competence, insight, and efforts result in poorer long-term outcomes of chronic illnesses such as diabetes and cardiovascular diseases and high cost of delivery of care.

New and improved methodologies are needed to address these various problems.

### SUMMARY

Accordingly, there is provided a computer-implemented method for rewarding individual patients for taking command of their health. The subject matter of the present patent application may be variously referred to herein in a non-limiting manner as the invention, the application, the method, or the software.

The application provides healthcare information aggregation, curation, and distribution services to patients and their proxies. The application may be implemented and used by patients and various healthcare providers such as physicians, dentists, hospitals, payors, pharmacies, and other independent healthcare providers and stakeholders.

The application may be implemented on mobile and personal computing devices. Personal devices commonly used for running software applications include smartphones, tablets, laptops, and wearable tech. Popular smartphones, such as the iPhone by Apple and the Galaxy series by Samsung, offer powerful performance for apps related to communication, productivity, and entertainment. Tablets, like the iPad and Microsoft Surface, afford portability and larger screens. Laptops, such as the MacBook and Dell XPS, provide even more power for resource-intensive applications. Wearable devices like smartwatches, such as the Apple Watch or Samsung Galaxy Watch, allow users to run health and fitness apps, receive notifications, and more.

The patient or other user is able to use the application as a “digital front door” for engaging with patients through a mobile software application and providing a variety of functions, depending on the user's or patient's needs. These include appointment scheduling, communication with patients, optimizing operational workflows, facility or provider rating and patient satisfaction management, telemedicine, transitional care management, chronic care management, and consolidation and storage of electronic medical records.

The invention improves patient engagement and encourages patients to become better consumers of health care by changing the patient's well-established health care behavioral and decision-making patterns.

The invention provides a patient-centered healthcare information network, which continuously enhances patient healthcare literacy and competence.

This information network is also the tool for developing avatar-based relationships between on the one hand, the patients and their proxies and, on the other hand, the application, care givers, and other persons in the patient's healthcare ecosystem with the aim of changing and enhancing the patient's health care journey.

The application is, in one embodiment, a platform for promoting interaction between patients and their providers that is capable of making every user a better and more knowledgeable consumer of healthcare services.

While health care providers may see the value of the invention, patients may choose not to engage with the platform at all, or to engage with it in the most minimal way possible as required by their provider. It is not sufficient for the platform to be simply secure, convenient, empathetic, and capable of providing important functionalities. Rather, the invention includes features to establish adequate use of the application by patients. Specifically, during an initial period of engagement (e.g., hours, days, weeks, or months), there is an incentive and reward system that encourages patients to have frequent, meaningful, and habitual interactions with the application.

The invention incentivizes patients to engage with its application through intangible rewards, such as enjoyment of use, social networking, and in-application digital rewards such as digital badges, trophies, or achievements. The invention may further incentivize patient participation through certain tangible rewards.

The objective of the incentive program is to habituate patients into meaningful and regular participation with the platform and application. The incentive program is primarily used to habituate the user to allocating a certain specified period of time (e.g., 15 to 30 minutes) for a certain specified frequency or duration (e.g., three or more times a week) to participating in the following interactions with the application:

Tutorials. Tutorials may include interactive, avatar-guided videos instructing the user in the in-app architecture, navigation, and functionalities. The user is asked by the application to view the tutorials and to demonstrate acquisition of skills necessary for using the app.

Data Transfer. With the user's authorization, the application obtains and stores in its databases the user's data from other sources, such as electronic medical records, when available. The user is asked to dedicate time and effort to validating the transferred data and when appropriate to provide, at the user's discretion, additional data requested by the patient's provider and to update the data at regular pre-specified intervals.

Utilization of Customer Functionalities. The application monitors users for their utilization of the numerous application functionalities, such as scheduling appointments or communicating with their provider, for as many of the user's health-related services and activities as possible.

Ensuring Meaningful Use of the Application. To achieve the goals of the incentive program, and the application as a whole, patients must meaningfully engage with the functions and data collection services available through the application. To ensure meaningful use, the application monitors a patient's engagement with the application by voice interactions with the avatar and by utilizing the camera on the patient's mobile device or personal computer, when available. Voice-based and video-based user-to-platform communication reduces the likelihood of use by anyone other than the patient, and the likelihood of faulty engagement through open-and-leave or open-and-ignore engagement with the application. This allows incorporation of user-performed tasks as well as time-of-open-app and user-requested app-dependent tasks into the definition of meaningful use.

The patient's engagement performance is assessed based on completion of pre-specified tasks and activities, such as tutorials, data reconciliation or transfer, or pre-visit preparations such as answering questionnaires from a provider. The application customizes and dynamically modifies incentive schedules for any given user relative to various parameters of meaningful use to optimize user engagement and performance. One skilled in the art will recognize that when the present disclosure refers to the application's assessing a patient's performance according to a “predefined set of criteria,” that the predefined set of criteria is not fixed; rather, the predefined set of criteria to assess patient engagement performance adapts to the particular patient and to the particular stage of the patient user's interaction with the application.

The application may use the following for quantification of meaningful use:
1. Frequency of engagement;
2. Frequency of content-driven, separate from task-or event-driven, engagement;
3. Duration of engagement;
4. Duration of content-driven, separate from task-or event-driven, engagement;
5. Compliance with task-or event-driven provider directives;
6. Compliance with content-driven, separate from task-or event-driven, engagement;
7. Quality of engagement
8. Quality of content-driven, separate from task-or event-driven, engagement;
9. Quality of proxy engagement by the patient;
10. Quality of content-driven, separate from task-or event-driven, proxy engagement by the patient;
11. Specific task-or event-related performance metrics;
12. Specific content-related performance metrics.

One skilled in the art will understand that the disclosure of one or more embodiments of the invention herein is not intended to limit the application of the invention. The invention is capable of implementation in other embodiments and may be carried out in different modalities and in different ways. Further, one skilled in the art should interpret the terminology used herein as descriptive and as non-limiting.

### DETAILED DESCRIPTION

### Definitions

An “avatar” is a digital representation of a human being that closely mimics the appearance, behaviors, and sometimes even the emotions of a real human. These avatars are designed to look like humans and can be either static images or highly detailed, animated 3D models. Key characteristics of an avatar include:
1. Human-Like Appearance: The avatar is designed to resemble a person, with realistic facial features, body proportions, and movements. Some avatars will be highly customizable by users to match their preferences or actual appearance.
2. Interactivity: The avatar will converse with the user and express appropriate emotions as if it were a human.
3. Facial Expressions and Gestures: The avatar may display detailed facial expressions and body gestures to simulate realistic communication.
4. AI-Powered Avatars: The avatar will be powered by artificial intelligence, enabling it to respond to users in real-time when appropriate.

An “uncommitted potential patient user” is an individual anonymous to the application passively exploring features and functionalities of the application.

A “committed potential patient user” is an individual uniquely identified to and as yet unverified by the application actively exploring and mastering navigation and utilities of the application.

An “active uncommitted patient user” is an individual uniquely identified to and verified by the application allowing the application unrestricted access to current and updated personal and health data

An “active committed patient user” is an individual meaningfully and consistently utilizing features and functionalities of the application.

“Meaningful use” means spending time on the application on activities that contribute to the active user's personal progress in achieving healthcare goals, executing healthcare-related tasks, or fulfilling in-application responsibilities. For example, meaningful use may encompass:
1. Interaction with Core Application Utilities: The active user will regularly engage with the specific utilities provided in the application, such as scheduling, procurement, documentation, resource management, skill development, or decision-making. Meaningful use may involve voice and video feedback to the application to ensure user attention and effort and accountability for completing certain tasks within these utilities each session.
2. Personal Progress Updates: Players are required to update information about themselves, for example, reflecting changes in health status, provider encounters, and medication changes.
3. Session Goals: The application may define for the active user clear goals for each session on the application separate from and additive to the user-derived objectives.
4. Social and Collaborative Elements: The active user may be required to engage in cooperative tasks with other users or provide feedback on shared experiences, concerns, and ideas, promoting a sense of community and contribution.
5. Skill Development and Real-World Impact: Meaningful use may also involve learning or improving specific skills such as diet, exercise, data management, and medical terminology. The application tracks, encourages, and facilitates the user's progress.
   By defining “meaningful use” around active engagement, task completion, and personal development, the sessions will have more value for the user.

The following non-limiting examples describe certain aspects of the invention. Specifically, the following examples illustrate possible interactions of patients with the application over time (i. e, the patient engagement/journey) as well as the operation of the incentive program, which adjusts based on temporal aspects of patient user engagement (including duration and continuity of use). The various numerical quantities (i.e., incentive amounts, durations, frequencies, etc.) in the following examples are for illustrative purposes only and will vary depending on the user and the user's needs and will be determined and adjusted by the application based on inputs received from the patient, proxies, or other data sources.

### Example 1

A 36-year-old patient JS with Type II diabetes visits the website version of the application and is informed by the avatar that he will receive a credit of $50 for reviewing the introductory videos illustrating the application after he completes the required introduction to the application in one or more such sessions totaling 2 or more hours within a 2-week period or sooner.

When JS completes the introductory videos, he is asked by the avatar if he is interested in downloading the application on his personal computer devices and learning how to use it. JS is informed by the avatar that if he chooses not to download the application and make an effort to master it, $5 of the $50 credit will vest as cash and the remaining $45 will be escrowed as credit should he wish to proceed with the application within the next month.

JS loads the application and is informed that he will receive an additional credit of $200 for completing the application training tutorials in 6 separate half hour sessions over a 3-week span or sooner. JS creates an account and provides the necessary identifications, verifications, and consents. The application queries the patient on the identities of the patient's health team, and the patient identifies the patient's primary care physician (a solo practitioner) and the patient's endocrinologist (who is employed by a large, regional medical practice). The application imports JS's data from the accessible hospital and provides EHRs.

When JS completes the tutorials, he is asked by the avatar if he is interested in becoming an active user of the application by creating a unique user identification, by providing appropriate identity verification, and by providing appropriate data access, transfer, and storage verification. JS is informed by the avatar that if he chooses not to become an active user and make regular meaningful use of the application over the next six months, $25 of the accumulated $250 credit will vest as cash and the remaining $225 will be escrowed as credit should he wish to proceed with the application within the next month. JS is instructed in the application's criteria for active meaningful use and is informed by the avatar that for the first 3 years he will receive additional credit of $10 for every hour of active meaningful use up to $50 a month. The avatar also informs JS that in the event of a prolonged disruption of meaningful active use of the application during the first six months, 10% of the accumulated total credit will vest as cash, and the remaining 90% will be escrowed as credit should he wish to resume meaningful active use of the application within the next month.

JS begins to use the application as instructed. After the first 6 months of meaningful active use of the application, 50% of the total accumulated credit vests as cash and the remaining 50% remains in escrow. After the next 6 months of meaningful use and every 6 months thereafter, JS receives 50% of the total accumulated credit.

### Example 2

A 59-year-old patient with hypertension and other age-related chronic conditions learns of the existence of the application from the patient's primary care physician. The patient is uncomfortable with incorporating a smartphone application into a daily health regimen due to the patient's comfort level with technology in general. The patient wishes to involve the patient's daughter as a healthcare proxy.

The patient, with assistance, downloads the application. An avatar within the app guides the patient in setting up a user account. The avatar further queries the patient for information regarding the patient's healthcare team, including any healthcare proxies. The patient provides his daughter's identifying information—full name, nature of relationship to the user, email, and phone number—and indicates that he wishes to designate her as a proxy. The patient provides consent for the proxy to have access to the patient's protected health information. The application directs the patient to inform the designated proxy that the application will contact the proxy by one or more indicated means.

The application is designed to ensure not only that the patient is uniquely identified and authenticated, but also that any proxy is independently uniquely identified and authenticated. At this point, the application has generated or received from a patient user the following: patient identifying information, a unique patient identifier, and unique patient device identifier, patent user provided designation of another person as a proxy, consent to share health information with that person, patient-user-provided contact information for that person. The application requires a further procedure to ensure that the patient user's information should be associated with, or may be accessed by, that person.

The application contacts the proxy and instructs the proxy to access the application or an independent verification tool. The proxy downloads the application onto her iPad. The proxy is guided by the application through an identification and authentication procedure.

The application associates the patient's unique user identifiers (account information and name provided, for example) as well as unique device identifier(s) with the proxy's provisional identifiers. The proxy's identifiers are provisional because the application is not yet satisfied as to the identity and authorization of the proxy.

The application engages both patient and proxy in a video-mediated further verification procedure to ensure that the proxy may have access to the patient's protected health information.

### Example 3

### Phase One of Rewards Program—Uncommitted Potential User

When first introduced to the application, an uncommitted potential user needs to be convinced that he or she can trust the application of the present invention with personal health information, that the application is uniquely user-centric and not dedicated to sales, promotion, or marketing; and that the application is reliably capable of facilitating execution of meaningfully important healthcare tasks and imparting meaningfully important healthcare skills and knowledge. Upon accessing the application, the uncommitted potential user is offered enrollment in phase one of the applications rewards program.

Phase one of the application's rewards program operates as follows. An uncommitted potential user is invited to complete avatar-mediated introductory tutorials designed to familiarize the user with the nature, scope, methodology, and capabilities of the application. After the uncommitted potential user completes one or more such introductory sessions totaling 2 or more hours within a 2-week period, the uncommitted potential user, will be entitled to $50 credit towards a reward account, should the user choose to become a committed potential user (see below). At the end of each session, the user will be shown the percentage of reward accumulation. If the uncommitted potential user chooses at any point after the total of 1 hour of meaningful introductory tutorials not to become a committed potential user, the $50 credit will be forfeited and replaced with an immediately available $5 reward for considering enrollment in the application. If the uncommitted potential user later reconsiders and chooses to become a committed potential user, the user's reward credit will be restored to $50.

### Phase Two of Rewards Program—Committed Potential User

An uncommitted potential user becomes a committed potential user upon establishing user identification and user and device authentication and upon granting certain necessary consents for personal healthcare information access, acquisition, and storage as well as completing initial avatar-assisted client-dependent personal and proxy information transfer.

Phase two of the application's rewards program operates as follows. The application encourages a committed potential user to complete 5 or more training sessions totaling 8 or more hours within a 2-week period designed to generate up-to-date personal healthcare records and to train the committed potential user in in-app navigation and customized utilization of its functionalities. During this training period the committed potential user is asked to complete 5-10 instances of application use for specific tasks, such as ordering medications or scheduling appointments. Completion of these milestones entitles the committed potential user to $200 credit in the rewards program for the total Phase 1 and Phase 2 credit of $250. If the potential user chooses at any point after the total of 1 hour of meaningful training tutorials not to become an active committed user and disenrolls at this stage, the $250 credit will be forfeited and replaced with an immediately available $25 reward for considering the application. If the committed potential user later reconsiders and chooses to become an active committed user, the user's reward credit is restored to $250.

### Phase Three of Rewards Program—Active Committed User

A committed potential user becomes an active committed user upon completing during the first 6 consecutive months of enrollment 30 or more hours of meaningful use of the application, with no less than 3 hours of meaningful use each of the first 6 months. To maintain his status as an active committed user, a user is required during the first 36 months of enrollment to undertake no less than 3 hours per month of meaningful use.

Phase three of the applications rewards program operates as follows for the first 36 months of user's enrollment in the application. An active committed user is awarded $10 credit towards rewards for every 1 hour of meaningful engagement with the application for up to $50 a month for 36 months. At the end of each session, the user is shown the total credit accumulated. After the first consecutive 6 months of active meaningful use, the active committed user receives 50% of total accumulated credit in Phase 1 and 2 and first 6 months of phase three. After the next consecutive 6 months of meaningful use and every 6 months thereafter, the active committed user will receive 50% of the accumulated credit as rewards. For every month during the first 36 months of enrollment in which the user fails, without mitigating circumstances, to meet the above minimal criteria of active meaningful use the user will forfeit 10% of the earned credit.

The user's rewards are disbursed as cash awards or used in a marketplace similar to that of many other rewards programs such as offered by airlines or credit card companies.

A core feature of the invention is the fact that the incentive awards are escrowed, or set aside, during periods of a patient user's disengagement, or non-use, of the application. That is, the patient user is motivated to resume use of the application because of the expiring or diminishing nature of the credit earned or available incentive awards.

Another feature of the invention is that the application maintains an account on behalf of the patient user that contains the funds described herein as the incentive awards. Such funds are provided by sources that include corporate or institutional sponsors as well as other parties with an interest in the patient's health. Corporate or institutional sponsors can include health-related vendors, employers, insurance providers, health plans, etc. Other parties with an interest in a patient's health include family members, significant others, or friends.

What is claimed is:

1. A computer-implemented method for improving patient healthcare engagement, the method comprising:
(a) enrolling a patient user in a patient education incentive-based reward application
(b) providing to a patient user one or more tutorials
(c) determining when the patient user has satisfied a predetermined goal for the one or more tutorials
(d) awarding the patient an incentive award that is recorded to a patient user account.

2. The method of claim 1 wherein the predetermined goal is the use of the application for a predetermined time and duration.

3. The method of claim 1 wherein the incentive award is a virtual currency.

4. The method of claim 1 wherein the incentive award is a coupon for an online health vendor.

5. The method of claim 1 wherein the one or more tutorials are directed to the use of the patient education incentive-based reward program.

6. The method of claim 1 wherein the one or more tutorials are directed to educating the patient user on one or more methods for transferring patient user data into the application.

7. The method of claim 1 further comprising motivating the patient user to continue or resume use of the application by informing the patient user that the incentive award expires.

8. A software application for implementing a method to cause a patient user to engage in the patient user's health, the method comprising:
(a) offering an uncommitted potential patient user enrollment in the application
(b) inviting the uncommitted potential patient user to complete one or more avatar-mediated introductory tutorials designed to familiarize the uncommitted potential patient user on a competency subject, wherein the competency subject involves the nature, scope, methodology, or capabilities of the application
(c) offering a phase one incentive award to the uncommitted potential patient user for completing the one or more tutorials, wherein the phase one incentive award has a first phase one predefined value
(d) determining that the uncommitted potential patient user has achieved a phase one predetermined goal with respect to the one or more tutorials according to a predefined set of criteria
(e) offering the uncommitted potential patient user the opportunity to become a committed potential user
(f) determining that the uncommitted potential patient user has accepted the offer to become a committed potential patient user
(g) crediting a patient user incentive account with the first phase one predefined value.

9. The method of claim 8 further comprising
(h) determining that the patient user has discontinued use of the application
(i) replacing the first phase one predefined value with a second phase one predefined value, wherein the second phase one predefined value is lower than the first phase one predefined value
(j) escrowing the difference between the first phase one predefined value and the second phase one predefined value that will either (i) expire after a period of non-use or (ii) be re-credited to the incentive account if the user resumes use
(k) determining that the patient user has discontinued use of the application
(l) motivating the patient user to resume use of the application by informing the patient user that the escrowed incentive credit is reduced at a pre-specified rate over time.

10. The method of claim 8 further comprising:
(h) offering a phase two incentive award to the committed potential patient user for achieving one or more phase two predetermined goals, wherein the phase two incentive award has a phase two predefined monetary value
(i) determining that the committed potential patient user has satisfactorily achieved the phase two predetermined goal
(j) crediting the patient user incentive account with the phase two predefined monetary value offering the committed potential patient user the opportunity to become an active committed patient user
(k) determining that the committed potential patient user has accepted the offer to become an active committed patient user.

11. The method of claim 10 wherein the one or more phase two predetermined goals includes the committed potential user providing one or more of identification credentials, authentication credentials, personal information, proxy information, and consents.

12. The method of claim 10 wherein the one or more phase two predetermined goals includes the committed potential patient user's satisfactory completion, according to a predefined set of criteria, of one or more training sessions designed to generate an up-to-date patient user healthcare record.

13. The method of claim 11 wherein the consents pertain to one or more of healthcare information access, acquisition, and storage.

14. The method of claim 10 further comprising
(l) determining that the patient user has discontinued use of the application
(m) replacing the balance of the patient user incentive account with a cash reward, wherein the cash award is a pre-specified percentage of the balance of the patient user incentive account
(n) escrowing the difference between the balance of the patient user incentive account and the cash award that will either (i) expire after a period of non-use or (ii) be re-credited to the incentive account if the user resumes use
(o) motivating the patient user to resume use of the application by informing the patient user that the escrowed incentive credit is reduced at a pre-specified rate over time.

15. The method of claim 10 further comprising
(l) offering a phase three incentive award to the patient user for achieving a phase three predetermined goal, wherein the phase three incentive award has a first phase three predefined monetary value
(m) requiring the patient user to engage in meaningful use of the application
(n) determining that the patient user has satisfactorily achieved meaningful use
(o) crediting the user incentive account with a phase three predefined monetary value.

16. The method of claim 15 further comprising repeating steps (m), (n), and (o) one or more times.

17. The method of claim 16 wherein the application adjusts the criteria for meaningful use based on patient user performance.
